(19) United States
(12) Patent Application Publication
(10) Pub. No.: US 2025/0289185 A1
(43) Pub. Date: Sep. 18, 2025

(54) METHOD FOR MANUFACTURING THREE-DIMENSIONAL SHAPED OBJECT

(71) Applicant: SEIKO EPSON CORPORATION, Tokyo (JP)

(72) Inventors: Kazuya KITADA, Matsumoto (JP); Eiji OKAMOTO, Matsumoto (JP); Akira SUGITA, Suwa (JP)

(21) Appl. No.: 19/074,512

(22) Filed: Mar. 10, 2025

(30) Foreign Application Priority Data
Mar. 12, 2024 (JP) 2024-037843

(51) Int. Cl. B29C 64/386; B33Y 10/00; B33Y 50/00

(52) U.S. Cl. CPC B29C 64/386; B33Y 50/00; B33Y 10/00

(57) ABSTRACT

A method for manufacturing a three-dimensional shaped object includes: accepting advertisement presence/absence information designating whether an advertisement is to be attached to a three-dimensional shaped object; generating shaping data for shaping a three-dimensional shaped object with advertisement, which is the three-dimensional shaped object with an advertisement attached, when information indicating that an advertisement is to be attached to the three-dimensional shaped object is accepted as the advertisement presence/absence information; and stacking a layer containing a shaping material, based on the shaping data, and thus shaping the three-dimensional shaped object with advertisement.

The present application is based on, and claims priority from JP Application Serial Number 2024-037843, filed Mar. 12, 2024, the disclosure of which is hereby incorporated by reference herein in its entirety.

### BACKGROUND

### 1. Technical Field

The present disclosure relates to a method for manufacturing a three-dimensional shaped object.

### 2. Related Art

A method for manufacturing a three-dimensional shaped object in which a plasticized material is ejected toward a stage and cured to shape a three-dimensional shaped object is known. In such a method for manufacturing a three-dimensional shaped object, a three-dimensional shaping device is controlled, based on shaping data, and thus shapes a three-dimensional shaped object.

For example, JP-A-2002-279295 describes a method of providing processing data, the method including: accepting original data from an external device together with information about whether processed data with an advertisement is desired; and generating processed data with advertisement data added thereto, based on the original data, when the information is information that processed data with an advertisement is desired.

JP-A-2002-279295 is an example of the related art.

JP-A-2002-279295 includes the description of processed data, but does not refer to an actual three-dimensional shaped object shaped by a three-dimensional shaping device. For a customer who cannot purchase a three-dimensional shaping device, an agency service in which an agent shapes a three-dimensional shaped object by using a three-dimensional shaping device is known, but such an agency service is expensive and therefore the agency service cannot be easily used.

### SUMMARY

According to an aspect of the present disclosure, a method for manufacturing a three-dimensional shaped object includes: accepting advertisement presence/absence information designating whether an advertisement is to be attached to a three-dimensional shaped object; generating shaping data for shaping a three-dimensional shaped object with advertisement, which is the three-dimensional shaped object with an advertisement attached, when information indicating that an advertisement is to be attached to the three-dimensional shaped object is accepted as the advertisement presence/absence information; and stacking a layer containing a shaping material, based on the shaping data, and thus shaping the three-dimensional shaped object with advertisement.

### BRIEF DESCRIPTION OF THE DRAWINGS

FIG. 1 shows an example of the configuration of an electronic commerce system according to an embodiment.

FIG. 2 shows an example of a flow of information and data in the electronic commerce system according to the embodiment.

FIG. 3 is a perspective view schematically showing a three-dimensional shaped object.

FIG. 4 is a flowchart illustrating processing performed by a processing device in a three-dimensional shaping system according to the embodiment.

FIG. 5 is a cross-sectional view schematically showing a three-dimensional shaping device in the three-dimensional shaping system according to the embodiment.

FIG. 6 is a flowchart illustrating a method for manufacturing a three-dimensional shaped object according to the embodiment.

### DESCRIPTION OF EMBODIMENTS

A preferred embodiment according to the present disclosure will now be described in detail with reference to the drawings. The embodiment described below does not unduly limit the contents of the present disclosure described in the claims. Also, not all the elements described below are necessarily essential elements of the present disclosure.

### 1. Three-Dimensional Shaping System

### 1.1. Configuration

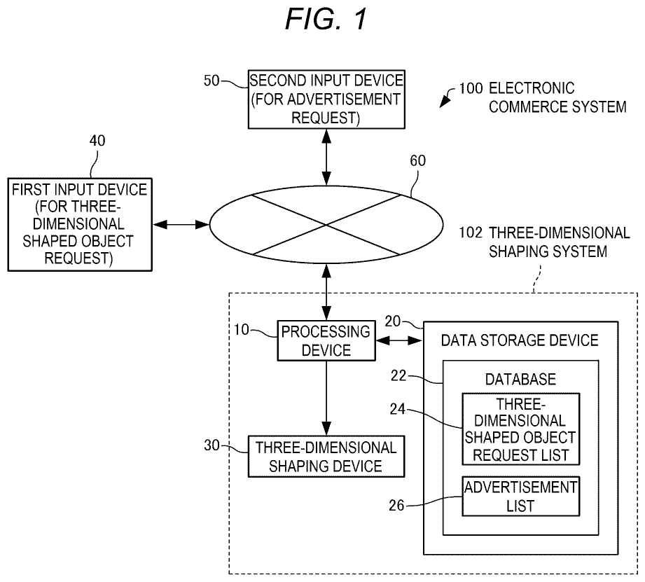

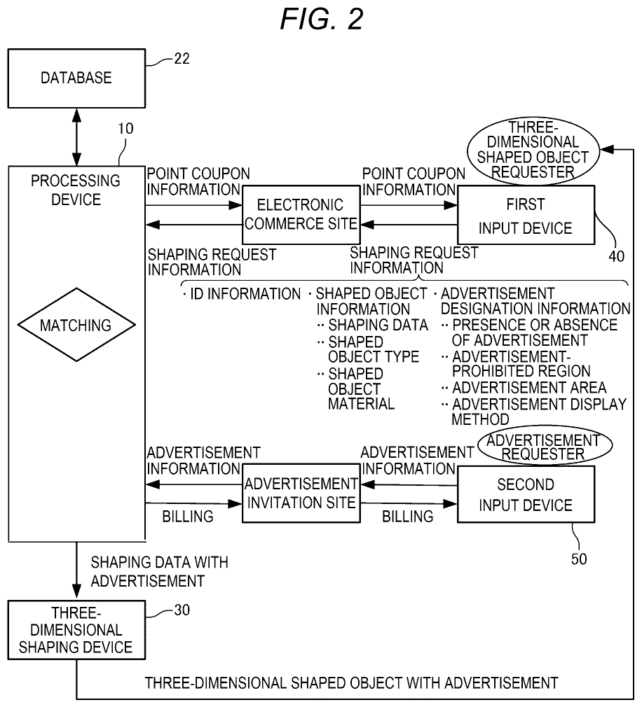

First, an electronic commerce system including a three-dimensional shaping system according to the present embodiment will be described with reference to the drawings. FIG. 1 shows an example of the configuration of an electronic commerce system 100 according to the present embodiment. FIG. 2 shows an example of a flow of information and data in the electronic commerce system 100 according to the present embodiment.

As illustrated in FIGS. 1 and 2, the electronic commerce system 100 includes, for example, a three-dimensional shaping system 102 including a processing device 10, a data storage device 20, and a three-dimensional shaping device 30, a first input device 40, a second input device 50, and a communication network 60. The three-dimensional shaping system 102 is a system for shaping a three-dimensional shaped object, based on information from a user who requests the shaping of a three-dimensional shaped object.

The processing device 10, the first input device 40, and the second input device 50 are connected to the communication network 60. The communication network 60 is configured with, for example, the internet or a local area network.

The first input device 40 is an input device operated by a user of an electronic commerce site provided by the processing device 10. The user is a requester who requests the shaping of a three-dimensional shaped object, and is a user who uses the three-dimensional shaped object that is shaped. The user operates the first input device 40 to access the electronic commerce site, and requests the shaping of a desired three-dimensional shaped object from the electronic commerce site. The first input device 40 is configured with, for example, a smartphone, a personal computer, or the like.

Prior to the request for the shaping of a three-dimensional shaped object, the user operates the first input device 40 to input user information. The user information is, for example, personal information such as the user's name, address, date of birth, occupation, and hobby. The first input device 40 transmits the input personal information to the processing device 10 via the communication network 60. The first input device 40 acquires a customer ID of the electronic commerce site from the processing device 10. The user accesses the electronic commerce site, using the customer ID, and inputs shaping request information for shaping a desired three-dimensional shaped object.

As illustrated in FIG. 2, the shaping request information input to the first input device 40 includes shaped object information about the three-dimensional shaped object, and advertisement designation information about an advertisement to be attached to the three-dimensional shaped object.

The shaped object information includes shaping data. The shaping data included in the shaped object information is data for shaping a three-dimensional shaped object without an advertisement attached. The shaping data is created, for example, by causing slicer software installed in a computer to read shape data. The shape data is data representing a target shape of the three-dimensional shaped object created using three-dimensional computer aided design (CAD) software, three-dimensional computer graphics (CG) software, or the like. As the shape data, for example, data in a standard triangulated language (STL) format, an additive manufacturing file format (AMF), or the like is used. The slicer software divides the target shape of the three-dimensional shaped object into layers with a predetermined thickness and creates divided shaping data for each layer. The shaping data is represented by, for example, a G code, an M code, or the like.

The shaped object information includes, for example, shaped object type information about the type of the three-dimensional shaped object shaped based on the shaping data. For example, when ordering a car component as a three-dimensional shaped object, the user operates the first input device 40 to input information indicating that the type of the three-dimensional shaped object is “car component” as the shaped object type information.

The shaped object information includes, for example, shaped object material information about the material of the three-dimensional shaped object shaped based on the shaping data. For example, when desiring an acrylonitrile-butadiene styrene (ABS) resin as the material of the three-dimensional shaped object, the user operates the first input device 40 to input information indicating that the material of the three-dimensional shaped object is “ABS resin” as the shaped object type information. When desiring a metal as the material of the three-dimensional shaped object, the user operates the first input device 40 to input information indicating that the material of the three-dimensional shaped object is “metal” as the shaped object type information.

The advertisement designation information includes advertisement presence/absence information designating whether to add an advertisement to the three-dimensional shaped object shaped based on the shaping data. For example, when desiring to add an advertisement to the three-dimensional shaped object, the user operates the first input device 40 to input information indicating that an advertisement is to be attached as the advertisement presence/absence information. When desiring not to add an advertisement to the three-dimensional shaped object, the user operates the first input device 40 to input information indicating that an advertisement is not to be attached as the advertisement presence/absence information.

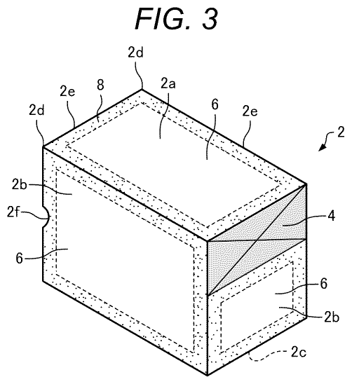

The advertisement designation information includes, for example, advertisement-prohibited region information about a region where an advertisement is prohibited from being attached, in the three-dimensional shaped objects formed based on the shaping data. For example, when inputting the information indicating that an advertisement is to be attached as the advertisement presence/absence information, the user operates the first input device 40 to input the advertisement-prohibited region information in the three-dimensional shaped object. FIG. 3 is a perspective view schematically showing a three-dimensional shaped object 2. In the three-dimensional shaped object 2, a region 4 is, for example, a part that comes into contact with an external member, not illustrated, and is a region that is not visually recognized even when the user uses the three-dimensional shaped object 2 that is shaped. Even when an advertisement is attached to such a region 4, the function as an advertisement is not implemented. Therefore, the user specifies the region 4 as the advertisement-prohibited region and inputs information indicating the specified region 4 as the advertisement-prohibited region information. In FIG. 3, for the sake of convenience, the advertisement-prohibited region 4 is shown in gray.

As illustrated in FIG. 2, the advertisement designation information includes, for example, advertisement area information about the size of the advertisement to be attached to the three-dimensional shaped object formed based on the shaping data. For example, when inputting the information indicating that an advertisement is to be attached as the advertisement presence/absence information, the user operates the first input device 40 to input the area of the region where the advertisement is attached as the advertisement area information.

The advertisement designation information includes, for example, advertisement display method information about the method for displaying the advertisement to be attached to the three-dimensional shaped object shaped based on the shaping data. The advertisement display method information includes, for example, at least one of information indicating that the advertisement is displayed by forming a concave-convex shape at a surface of the three-dimensional shaped object and information indicating that the advertisement is displayed by using a plurality of shaping materials having different characteristics. When inputting the information indicating that the advertisement is displayed by forming a concave-convex shape at a surface of the three-dimensional shaped object, as the advertisement display method information, the user operates the first input device 40 to input the shaping data for shaping the three-dimensional shaped object including the concave-convex shape functioning as the advertisement. The concave-convex shape functioning as the advertisement may be a concave-convex shape that changes the reflected light by slightly changing the surface roughness. When inputting the information indicating that the advertisement is displayed by using a plurality of shaping materials having different characteristics, as the advertisement display method information, the user operates the first input device 40 to input, for example, information indicating that only the part of the advertisement is formed of a different material, information indicating that only the part of the advertisement is made different in color by using a white ABS and a black ABS even though these are the same material, information indicating that the part of the advertisement is formed of a material having a different magnetism, and the like.

The first input device 40 transmits the customer ID of the user, the shaped object information, and the advertisement designation information, thus input, to the processing device 10 via the communication network 60 as the shaping request information. The processing device 10 receives the shaping request information transmitted from the first input device 40 via the communication network 60. Then, the processing device 10 transmits the customer ID of the user, the personal information associated with the customer ID, the shaped object information, and the advertisement designation information, to the data storage device 20.

Although only one first input device 40 is illustrated in FIGS. 1 and 2, in practice, the first input device 40 of each user of the electronic commerce site is connected to the communication network 60.

The second input device 50 is an input device for advertisement request operated by an advertisement requester who makes a request for an advertisement to an advertisement invitation site provided by the processing device 10. The second input device 50 is configured with, for example, a smartphone, a personal computer, or the like. The second t device 50 may be configured with a dedicated terminal for advertisement request.

Advertisement information is input to the second input device 50. The advertisement requester operates the second input device 50 to input the advertisement information. Specifically, the advertisement requester operates the second input device 50 to cause a display unit of the second input device 50 to display an advertisement information input screen for requesting an advertisement, and inputs the advertisement information to the advertisement information input screen. The second input device 50 transmits the input advertisement information to the processing device 10 via the communication network 60. Then, the processing device 10 transmits the advertisement information to the data storage device 20.

The advertisement information input to the second input device 50 may be, for example, a two-dimensional barcode, the company name of an advertisement requester, or the like. The two-dimensional barcode as the advertisement information can be read by a predetermined device such as a smartphone and the site linked to the two-dimensional barcode can thus be viewed in the device. The site linked to the two-dimensional barcode may be, for example, a site related to the description of the product handled by the advertisement requester and the homepage of the company of the requester.

The data storage device 20 includes a database 22. The data storage device 20 adds the shaping request information transmitted from the first input device 40 to a shaped object request list 24 in the database 22. The shaped object request list 24 stores the customer ID of the user, the personal information of the user, the shaped object information, and the advertisement designation information, for each piece of previously transmitted shaping request information. Moreover, the data storage device 20 adds the advertisement information transmitted from the second input device 50 to an advertisement list 26 in the database 22. The advertisement list 26 stores the previously transmitted advertisement information.

The processing device 10 provides an electronic commerce site. The processing device 10 functions as a server that performs processing for a transaction by a user who is a customer at the electronic commerce site. Moreover, the processing device 10 provides an advertisement invitation site. The processing device 10 functions as a server that performs processing for a request by an advertisement requester at the advertisement invitation site.

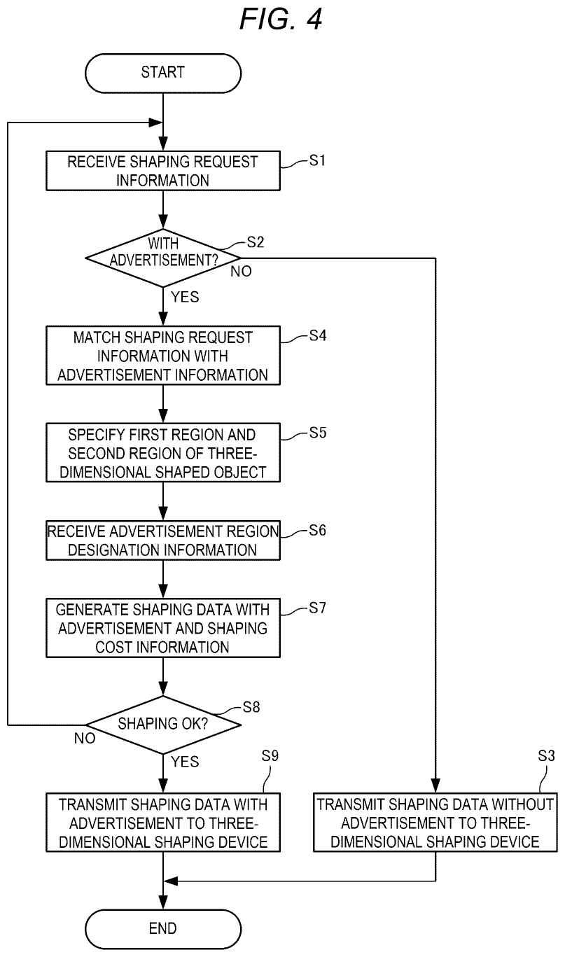

FIG. 4 is a flowchart illustrating the processing performed by the processing device 10. FIG. 4 illustrates processing from the reception of request information by the processing device 10 to the transmission of shaping data to the three-dimensional shaping device 30.

The processing device 10 starts the processing in response to the user operating the first input device 40 to access the electronic commerce site.

As illustrated in FIG. 4, in step S1, the processing device 10 receives the shaping request information transmitted from the first input device 40 via the communication network 60.

Next, in step S2, the processing device 10 determines whether an advertisement is to be attached to the three-dimensional shaped object. When the advertisement presence/absence information of the received shaping request information is information indicating that an advertisement is not attached to the three-dimensional shaped object (“NO” in step S2), the processing device 10 in step S3 transmits the received shaping data without an advertisement attached, to the three-dimensional shaping device 30. Then, the processing device 10 ends the processing.

Meanwhile, when the advertisement presence/absence information of the received shaping request information is information indicating that an advertisement is to be attached to the three-dimensional shaped object (“YES” in step S2), the processing device 10 in step S4 matches the received shaping request information with the advertisement information. For example, the processing device 10 selects advertisement information related to the received shaping request information from among the advertisement information stored in the advertisement list 26 in the database 22. An example of a method of selecting advertisement information related to the shaping request information will now be described.

The processing device 10 may select the related advertisement information, based on the shaped object type information included in the shaping request information. For example, when “car component” is input as the shaped object type information, the processing device 10 selects the advertisement information of a company related to the car from among the advertisement information stored in the advertisement list 26.

The processing device 10 may select the related advertisement information, based on the shaped object material information included in the shaping request information. For example, when “ABS resin” is input as the shaped object material information, the processing device 10 selects the advertisement information of a company related to the resin from among the advertisement information stored in the advertisement list 26. When “metal” is input as the shaped object material information, the processing device 10 selects the advertisement information of a company related to the metal from the advertisement information stored in the advertisement list 26.

The processing device 10 may select the related advertisement information from among the advertisement information stored in the advertisement list 26, based on the user information associated with the customer ID included in the shaping request information. For example, when “car” is input as the information of the hobby included in the user information, the processing device 10 selects the advertising information of a company related to the car from among the advertising information stored in the advertisement list 26.

The processing device 10 may perform machine learning based on the shaping request information stored in the shaped object request list 24 in the database 22 and the advertisement information stored in the advertisement list 26 in the database 22, and may select the advertisement information related to the received shaping request information, based on the machine learning. The processing device 10 may perform machine learning by an analysis method such as cross tabulation, cluster analysis, association analysis, logistic regression analysis, decision tree analysis, or main component analysis, or may perform machine learning by deep learning.

Next, in step S5, the processing device 10 specifies a first region 6 and a second region 8 on the three-dimensional shaped object 2 to be shaped based on the shaping data, as illustrated in FIG. 3. The shape of the three-dimensional shaped object 2 is not particularly limited, but in the illustrated example, a substantially rectangular parallelepiped shape is employed. The three-dimensional shaped object 2 includes the first region 6 and the second region 8. The first region 6 and the second region 8 are regions excluding the advertisement-prohibited region 4. In FIG. 3, for the sake of convenience, the second region 8 is indicated by small dots.

The first region 6 is a region with high visibility. For example, a plurality of first regions 6 are provided. The first region 6 is, for example, a region of an upper surface 2a of the three-dimensional shaped object 2 and has an area smaller than the upper surface 2a. The first region 6 is a region that does not include sides 2e of the upper surface 2a of the three-dimensional shaped object 2. The first region 6 is, for example, a region separated at a predetermined distance from the sides 2e of the upper surface 2a and having an area equal to or larger than a predetermined value. The first region 6 is, for example, a region of a side surface 2b of the three-dimensional shaped object 2 and has a smaller area than the side surface 2b. The first region 6 is a region that does not include the sides 2e of the side surface 2b of the three-dimensional shaped object 2. The first region 6 is, for example, a region separated at a predetermined distance from the sides 2e of the side surface 2b and having an area equal to or larger than a predetermined value. A bottom surface 2c of the three-dimensional shaped object 2 is not the first region 6.

The second region 8 is a region having a lower visibility than the first region 6. The second region 8 may be a region that is viewed by the user a fewer number of times than the first region 6 when the three-dimensional shaped object 2 is shaped. The second region 8 may be a region where, when characters are attached as an advertisement, it is harder for the user to read the content of the advertisement than in the first region 6. The second region 8 may be a region where, when a two-dimensional barcode is attached as an advertisement, it is harder for a predetermined device to read the two-dimensional barcode than in the first region 6.

The second region 8 is, for example, a region including corners 2d of the three-dimensional shaped object 2. The second region 8 is, for example, a region within a predetermined distance from the apexes of the corners 2d and a region within a predetermined distance from the sides 2e of the three-dimensional shaped object 2. The second region 8 includes, for example, the bottom surface 2c of the three-dimensional shaped object 2. The second region 8 includes, for example, a curved part 2f of the three-dimensional shaped object 2. The area of the second region 8 is, for example, smaller than the area of the first region 6.

Next, as illustrated in FIG. 4, in step S6, the processing device 10 receives advertisement region designation information. Specifically, the processing device 10 causes the electronic commerce site to display a preview of a three-dimensional model of the three-dimensional shaped object 2 in which the first region 6 and the second region 8 are specified. The user operates the first input device 40 to access the electronic commerce site, and checks the three-dimensional model of the three-dimensional shaped object 2 in which the first region 6 and the second region 8 are specified. The user operates the first input device 40 to generate advertisement region designation information, which is information indicating whether to attach the advertisement to the first region 6 or to the second region 8. Then, the user transmits the advertisement region designation information to the processing device 10 via the communication network 60.

Next, in step S7, the processing device 10 generates shaping data with advertisement, of the three-dimensional shaped object with the advertisement attached, based on the received advertisement region designation information. The processing device 10 causes the electronic commerce site to display a preview of a three-dimensional model of the three-dimensional shaped object with the advertisement attached, based on the generated shaping data with advertisement.

Also, the processing device 10 generates shaping cost information, based on the shaping data with advertisement. The shaping cost information includes information about the cost of the three-dimensional shaped object when the advertisement is attached to the region selected by the advertisement region designation information. The shaping cost information also includes information about the cost of the three-dimensional shaped object when the advertisement is attached to a region that is not selected by the advertisement region designation information. For example, when the first region 6 is selected by the advertisement region designation information, the processing device 10 estimates a first shaping cost in the case of shaping the three-dimensional shaped object 2 with the advertisement attached to the first region 6, and a second shaping cost in the case of shaping the three-dimensional shaped object 2 with the advertisement attached to the second region 8, which is not selected by the advertisement region designation information. The second shaping cost is higher than the first shaping cost. The processing device 10 transmits the first shaping cost and the second shaping cost to the electronic commerce site in addition to the preview of the three-dimensional model of the three-dimensional shaped object with the advertisement attached.

Next, in step S8, the processing device 10 determines whether to perform the shaping of the three-dimensional shaped object with the advertisement attached. Specifically, the user operates the first input device 40 to access the electronic commerce site, and checks the preview of the three-dimensional model of the three-dimensional shaped object with the advertisement attached and the shaping cost. Then, the user operates the first input device 40 to transmit shaping permission/no-permission information about whether to perform the shaping of the three-dimensional shaped object with advertisement, to the electronic commerce site. The processing device 10 receives the shaping permission/no-permission information from the electronic commerce site.

When the received shaping permission/no-permission information indicates that the shaping of the three-dimensional shaped object is not permitted (“NO” in step S8), the processing device 10 returns the processing to step S1. In this case, for example, the user may change the advertisement area information included in the shaping request information and the advertisement display method information included in the shaping request information. The processing device 10 may receive the changed shaping request information in step S1. The processing device 10 repeats steps S1 to S8 until the result of the determination is “YES” in step S8.

Meanwhile, when the received shaping permission/no-permission information indicates that the shaping of the three-dimensional shaped object is permitted (“YES” in step S8), the processing device 10 transmits the shaping data with the advertisement to the three-dimensional shaping device 30. Then, the processing device 10 ends the processing.

As illustrated in FIGS. 1 and 2, the three-dimensional shaping device 30 shapes the three-dimensional shaped object, based on the shaping data with advertisement received from the processing device 10. When the three-dimensional shaping device 30 receives the shaping data without advertisement from the processing device 10, the three-dimensional shaping device 30 shapes the three-dimensional shaped object, based on the received shaping data without advertisement. The three-dimensional shaping device 30 will be described in detail later.

The three-dimensional shaped object with advertisement shaped by the three-dimensional shaping device 30 is delivered to the user, for example, via a delivery company or the like. The user himself/herself may go to receive the three-dimensional shaped object with advertisement that is shaped.

The user, upon receiving the three-dimensional shaped object with advertisement, reads a two-dimensional barcode as the advertisement attached to the three-dimensional shaped object with advertisement, for example, using a device such as a smartphone. When the linked site is viewed by reading the two-dimensional barcode, the processing device 10 accesses the database 22 and adds at least one of “points” and “coupon” to the personal information of the customer who is the user. Then, the processing device 10 transmits information indicating that at least one of the predetermined points and the coupon is issued, to the first input device 40 of the user via the electronic commerce site.

The processing device 10 feeds back, to the database 22, viewing information indicating the personal information of the user, the advertisement information, and the number of times the linked site is viewed by reading the two-dimensional barcode. When advertisement information related to request information is selected based on machine learning, machine learning is performed based on the fed back information. In the database 22, the advertisement information and the number of times of viewing included in the viewing information may be stored in association with each other.

When the company name of the advertisement requester is attached as the advertisement attached to the three-dimensional shaped object with advertisement, delivery object with a two-dimensional barcode to which a site related to the description of the product handled by the company of the advertisement requester is linked may be delivered separately to the user.

The advertisement requester whose advertisement is attached to the three-dimensional shaped object with advertisement is charged a predetermined fee, for example, after the three-dimensional shaped object with advertisement is shaped. The advertisement requester may be charged a predetermined fee when the advertisement information is input to the advertisement invitation site, instead of after the three-dimensional shaped object with advertisement is shaped.

### 1.2. Three-Dimensional Shaping Device

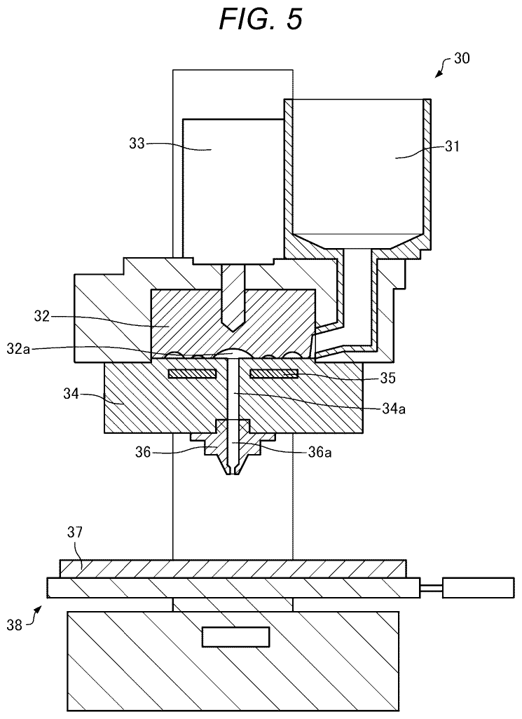

The three-dimensional shaping device in the three-dimensional shaping system according to the present embodiment will now be described with reference to the drawings. FIG. 5 is a cross-sectional view schematically showing the three-dimensional shaping device 30 of the three-dimensional shaping system 102 according to the present embodiment.

As illustrated in FIG. 5, the three-dimensional shaping device 30 includes, for example, a material supply unit 31, a flat screw 32, a motor 33, a barrel 34, a heater 35, a nozzle 36, a stage 37, and a position changing unit 38. The three-dimensional shaping device 30 is, for example, a three-dimensional shaping device of the fused deposition modeling (FDM) (registered trademark) type.

A raw material of the three-dimensional shaped object is supplied to the material supply unit 31. The raw material is introduced into a spiral groove 32a formed in the flat screw 32 from the material supply unit 31. The spiral groove 32a is formed on the surface of the flat screw 32 on the side of the barrel 34. The flat screw 32 conveys the raw material to a communication hole 34a formed at the center of the barrel 34 while being rotated by the motor 33.

The raw material of the three-dimensional shaped object is heated by the heater 35 while passing through the spiral groove 32a. Thus, the raw material becomes a plasticized shaping material. The shaping material passes through the communication hole 34a and a nozzle hole 36a and is injected onto the stage 37 from the nozzle 36.

The three-dimensional shaping device 30 drives the position changing unit 38 to change the relative position between the nozzle 36 and the stage 37 while ejecting the plasticized shaping material to the stage 37 from the nozzle 36, based on the shaping data. Thus, the three-dimensional shaping device 30 shapes a three-dimensional shaped object with advertisement in a predetermined shape in which a plurality of layers is stacked, on the stage 37.

### 2. Method for Manufacturing Three-Dimensional Shaped Object

### 2.1. Flow

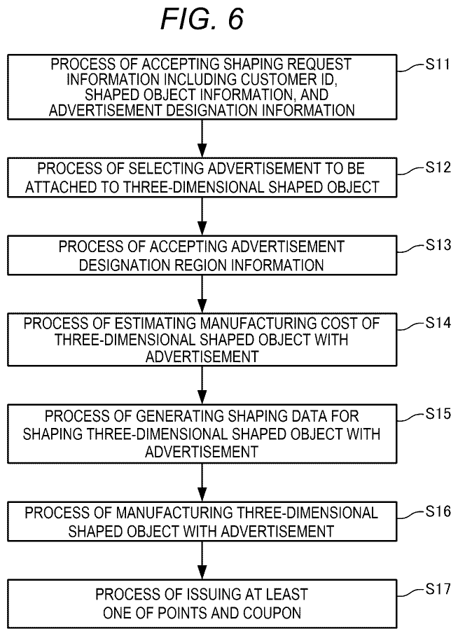

A method for manufacturing a three-dimensional shaped object according to the present embodiment will now be described with reference to the drawings. FIG. 6 is a flowchart illustrating the method for manufacturing a three-dimensional shaped object according to the present embodiment. In the method for manufacturing a three-dimensional shaped object according to the present embodiment, for example, one of the processing device 10 and the three-dimensional shaping device 30 provided in the three-dimensional shaping system 102 performs each process shown in FIG. 6.

First, in step S11, the shaping request information including the customer ID, the shaped object information, and the advertisement designation information is accepted. The customer ID is associated with the user information about the user requesting the shaping of a three-dimensional shaped object. The shaped object information includes the shaped object type information about the type of the three-dimensional shaped object. The advertisement designation information includes the advertisement presence/absence information designating whether an advertisement is to be attached to the three-dimensional shaped object, and the advertisement-prohibited region information about a region where an advertisement is prohibited from being attached, in the three-dimensional shaped object.

Next, in step S12, an advertisement to be attached to the three-dimensional shaped object is selected. For example, the advertisement to be attached to the three-dimensional shaped object is selected, based on at least one of the user information and the shaped object type information.

Next, in step S13, the advertisement region designation information in the three-dimensional shaped object 2 is accepted. For example, in the three-dimensional shaped object 2, the advertisement designation information is information indicating which of the first region 6 and the second region 8 having a lower visibility than the first region 6 the advertisement is to be attached to. The second region 8 is at least one of the bottom surface 2c, the corner 2d, the curved part 2f, and a region having a smaller area than the first region 6, of the three-dimensional shaped object 2.

Next, in step S14, the shaping cost of the three-dimensional shaped object with advertisement is estimated, based on the received advertisement presence/absence information. In this process, when information indicating that the advertisement is to be attached to the second region 8 is accepted as the advertisement region designation information, the shaping cost is estimated to be higher than when information indicating that the advertisement is to be attached to the first region 6 is accepted as the advertisement region designation information.

Next, in step S15, when information indicating that the advertisement is to be attached to the three-dimensional shaped object is accepted as the advertisement presence/absence information, the shaping data for shaping the three-dimensional shaped object with advertisement, which is the three-dimensional shaped object with the advertisement attached, is generated.

Next, in step e shaping material is ejected and layers containing the shaping material are stacked, based on the shaping data, and the three-dimensional shaped object with advertisement is thus shaped. In this process, for example, the advertisement is attached by at least one of forming a concave-convex shape and using a plurality of shaping materials having different characteristics.

Next, in step S17, the advertisement of the three-dimensional shaped object with advertisement can be viewed in a device by being read by the device, and when the advertisement of the three-dimensional shaped object with advertisement is read by the device, at least one of points and coupon is issued.

Thus, a three-dimensional shaped object can be manufactured. The three-dimensional shaped object with advertisement may be shaped by various shaping methods such as an inkjet method, a direct metal deposition (DMD) method, and a powder bed fusion method.

### 2.2. Advantageous Effects

A method for manufacturing a three-dimensional object includes: accepting advertisement shaped presence/absence information designating whether an advertisement is to be attached to a three-dimensional shaped object; generating shaping data for shaping a three-dimensional shaped object with advertisement, which is the three-dimensional shaped object with an advertisement attached, when information indicating that an advertisement is to be attached to the three-dimensional shaped object is accepted as the advertisement presence/absence information; and stacking a layer containing a shaping material, based on the shaping data, and thus shaping the three-dimensional shaped object with advertisement. Therefore, in the method for manufacturing a three-dimensional shaped object, when information indicating that an advertisement is to be attached to the three-dimensional shaped object is accepted as the advertisement presence/absence information, a part of the shaping cost of the three-dimensional shaped object with advertisement can be charged from the advertisement requester that provides the advertisement. Thus, the shaping cost of the three-dimensional shaped object with advertisement can be reduced. Therefore, the user can easily use the method for manufacturing a three-dimensional shaped object.

The method for manufacturing a three-dimensional shaped object includes accepting advertisement-prohibited region information about the region 4, where an advertisement is prohibited from being attached, in the three-dimensional shaped object. The region 4 is a region that is not visually recognized even when the user uses the three-dimensional shaped object with advertisement that is shaped. Thus, in the method for manufacturing a three-dimensional shaped object, an advertising appeal of the advertisement can be ensured.

In the method for manufacturing a three-dimensional shaped object, in the shaping of the three-dimensional shaped object with advertisement, an advertisement is attached by at least one of forming a concave-convex shape and using a plurality of shaping materials having different characteristics. Therefore, in the method for manufacturing a three-dimensional shaped object, the user can select a display method of the advertisement.

The method for manufacturing a three-dimensional shaped object includes estimating the shaping cost of the three-dimensional shaped object with advertisement, based on the accepted advertisement presence/absence information. Therefore, in the method for manufacturing a three-dimensional shaped object, the user can determine whether to perform the shaping of the three-dimensional shaped object with advertisement, based on the estimated shaping cost.

The method for manufacturing a three-dimensional shaped object includes accepting advertisement region designation information, which is information indicating which of the first region 6 and the second region 8 having a lower visibility than the first region 6 advertisement is to be attached to, in the three-dimensional shaped object, and in the estimating of the shaping cost, when information indicating that an advertisement is to be attached to the second region 8 is accepted as the advertisement region designation information, the shaping cost is estimated to be higher than when information indicating that an advertisement is to be attached to the first region 6 is accepted as the advertisement region designation information. Therefore, in the method for manufacturing a three-dimensional shaped object, for example, a three-dimensional shaped object with advertisement can be acquired inexpensively by selecting the attachment of the advertisement to the first region 6.

In the method for manufacturing a three-dimensional shaped object, the second region 8 is at least one of the bottom surface 2c, the corner 2d, the curved part 2f, and a region having a smaller area than the first region 6, of the three-dimensional shaped object 2. Therefore, in the method for manufacturing a three-dimensional shaped object, the second region 8 has a lower visibility than the first region 6.

In the method for manufacturing a three-dimensional shaped object, the advertisement of the three-dimensional shaped object with advertisement can be viewed in a device by being read by the device, and the method includes issuing at least one of points and a coupon when the advertisement of the three-dimensionally shaped object with advertisement is read by the device. Therefore, in the method for manufacturing a three-dimensional shaped object, the user can reuse the three-dimensional shaping system 102 inexpensively.

The method of manufacturing a three-dimensional shaped object includes accepting one of user information about a user who requests shaping of a three-dimensional shaped object and shaped object type information about a type of the three-dimensional shaped object, and selecting an advertisement to be attached to the three-dimensional shaped object, based on at least one of the user information and the shaped object type information. Therefore, in the method for manufacturing a three-dimensional shaped object, the advertisement related to the shaping data of the three-dimensional shaped object transmitted from the user can be attached to the three-dimensional shaped object.

The foregoing embodiment and modification examples are examples, and the present disclosure is not limited thereto. For example, the embodiment and modification examples may be combined as appropriate.

The present disclosure includes substantially the same configurations as the configurations described in the embodiment, such as a configuration having the same function, method, and result, or a configuration having the same object and effect. The present disclosure includes a configuration in which a non-essential part of the configurations described in the embodiment is replaced. Also, the present disclosure includes a configuration that achieves the same function and effect or a configuration that can achieve the same purpose as the configurations described in the embodiment. Also, the present disclosure includes a configuration formed by adding a known technique to the configurations described in the embodiment.

The following contents are derived from the foregoing embodiment and the modification examples.

According to an aspect of the present disclosure, a method for manufacturing a three-dimensional shaped object includes: accepting advertisement presence/absence information designating whether an advertisement is to be attached to a three-dimensional shaped object; generating shaping data for shaping a three-dimensional shaped object with advertisement, which is the three-dimensional shaped object with an advertisement attached, when information indicating that an advertisement is to be attached to the three-dimensional shaped object is accepted as the advertisement presence/absence information; and stacking a layer containing a shaping material, based on the shaping data, and thus shaping the three-dimensional shaped object with advertisement.

The user can easily use the method for manufacturing a three-dimensional shaped object.

According to another aspect, the method for accepting advertisement-prohibited region information about a region where an advertisement is prohibited from being attached, in the three-dimensional shaped object.

In the method for manufacturing a three-dimensional shaped object, an advertising appeal of the advertisement can be ensured.

According to another aspect, in the method for manufacturing a three-dimensional shaped object, in the shaping of the three-dimensional shaped object with advertisement, an advertisement may be attached by at least one of forming a concave-convex shape and using a plurality of the shaping materials having different characteristics.

In the method for manufacturing a three-dimensional shaped object, the user can select a display method of the advertisement.

According to another aspect, the method for manufacturing a three-dimensional shaped object may include estimating a shaping cost of the three-dimensional shaped object with advertisement, based on the accepted advertisement presence/absence information.

In the method for manufacturing a three-dimensional shaped object, the user can determine whether to perform the shaping of the three-dimensional shaped object with advertisement, based on the estimated shaping cost.

According to another aspect, the method for manufacturing a three-dimensional shaped object may include accepting advertisement region designation information indicating first region and a second region having a lower visibility than the first region an advertisement is to be attached to, in the three-dimensional shaped object, and in the estimating of the shaping cost, when information indicating that an advertisement is to be attached to the second region is accepted as the advertisement region designation information, the shaping cost may be estimated to be higher than when information indicating that an advertisement is to be attached to the first region is accepted as the advertisement region designation information.

In the method for manufacturing a three-dimensional shaped object, for example, a three-dimensional shaped object with advertisement can be acquired inexpensively by selecting the attachment of the advertisement to the first region.

According to another aspect, in the method for manufacturing a three-dimensional shaped object, the second region may be at least one of a bottom surface, a corner, a curved part, and a region having a smaller area than the first region, of the three-dimensional shaped object.

In the method for manufacturing a three-dimensional shaped object, the second region has a lower visibility than the first region.

According to another aspect, in the method for manufacturing a three-dimensional shaped object, the advertisement of the three-dimensional shaped object with advertisement can be viewed in a device by being read by the device, and the method may include issuing at least one of points and a coupon when the advertisement of the three-dimensional shaped object with advertisement is read by the device.

According to the method for manufacturing a three-dimensional shaped object, the user can inexpensively reuse the three-dimensional shaping system for executing the three-dimensional shaped object manufacturing method.

According to another aspect, the method of manufacturing a three-dimensional shaped object may include accepting one of user information about a user who requests shaping of a three-dimensional shaped object and shaped object type information about a type of the three-dimensional shaped object, and selecting an advertisement to be attached to the three-dimensional shaped object, based on at least one of the user information and the shaped object type information.

In the method for manufacturing a three-dimensional shaped object, the advertisement related to the shaping data of the three-dimensional shaped object transmitted from the user can be attached to the three-dimensional shaped object.

What is claimed is:

1. A method for manufacturing a three-dimensional shaped object, the method comprising:
accepting advertisement presence/absence information designating whether an advertisement is to be attached to a three-dimensional shaped object;
generating shaping data for shaping a three-dimensional shaped object with advertisement, which is the three-dimensional shaped object with an advertisement attached, when information indicating that an advertisement is to be attached to the three-dimensional shaped object is accepted as the advertisement presence/absence information; and
stacking a layer containing a shaping material, based on the shaping data, and thus shaping the three-dimensional shaped object with advertisement.

2. The method for manufacturing a three-dimensional shaped object according to claim 1, comprising:
accepting advertisement-prohibited region information about a region where an advertisement is prohibited from being attached, in the three-dimensional shaped object.

3. The method for manufacturing a three-dimensional shaped object according to claim 1, wherein
in the shaping the three-dimensional shaped object with advertisement,
an advertisement is attached by at least one of forming a concave-convex shape and using a plurality of the shaping materials having different characteristics.

4. The method for manufacturing a three-dimensional shaped object according to claim 1, comprising:
estimating a shaping cost of the three-dimensional shaped object with advertisement, based on the accepted advertisement presence/absence information.

5. The method for manufacturing a three-dimensional shaped object according to claim 4, comprising:
accepting advertisement region designation information indicating which of a first region and a second region having a lower visibility than the first region an advertisement is to be attached to, in the three-dimensional shaped object, wherein
in the estimating the shaping cost,
when information indicating that an advertisement is to be attached to the second region is accepted as the advertisement region designation information, the shaping cost is estimated to be higher than when information indicating that an advertisement is to be attached to the first region is accepted as the advertisement region designation information.

6. The method for manufacturing a three-dimensional shaped object according to claim 5, wherein
the second region is at least one of a bottom surface, a corner, a curved part, and a region having a smaller area than the first region, of the three-dimensional shaped object.

7. The method for manufacturing a three-dimensional shaped object according to claim 1, wherein
the advertisement of the three-dimensional shaped object with advertisement can be viewed in a device by being read by the device, and
the method comprises issuing at least one of points and a coupon when the advertisement of the three-dimensional shaped object with advertisement is read by the device.

8. The method of manufacturing a three-dimensional shaped object according to claim 1, comprising:
accepting one of user information about a user who requests shaping of a three-dimensional shaped object and shaped object type information about a type of the three-dimensional shaped object; and
selecting an advertisement to be attached to the three-dimensional shaped object, based on at least one of the user information and the shaped object type information.
